(19) United States
(12) Patent Application Publication
(10) Pub. No.: US 2015/0167566 A1
(43) Pub. Date: Jun. 18, 2015

(54) HEAT MANAGEMENT SYSTEM AND METHOD FOR ENGINE

(71) Applicants: Hyundai Motor Company, Seoul (KR); Kia Motors Corporation, Seoul (KR)

(72) Inventor: Seung Ho MOK, Yongin-si (KR)

(73) Assignees: Hyundai Motor Company, Seoul (KR); Kia Motors Corporation, Seoul (KR)

(21) Appl. No.: 14/465,660

(22) Filed: Aug. 21, 2014

(30) Foreign Application Priority Data
Dec. 18, 2013 (KR) 10-2013-0158390

(51) Int. Cl. F02D 35/02; F01P 3/00

(52) U.S. Cl. CPC F02D 35/025; F01P 3/00

(57) ABSTRACT

Disclosed are a heat management system and a method for an engine. The system may include a cooling water temperature sensor configured to detect an engine cooling water temperature, an engine control unit configured to determine whether the engine control unit enters a torque reduction mode depending on the cooling water temperature detected by the cooling water temperature sensor and perform an engine control to reduce an engine torque in a torque reduction mode entry condition, and a display unit configured to be controlled by the engine control unit to display whether the engine control unit enters the torque reduction mode.

### CROSS-REFERENCE TO RELATED APPLICATION

The present application claims priority of Korean Patent Application Number 10-2013-0158390 filed on Dec. 18, 2013, the entire contents of which application are incorporated herein for all purposes by this reference.

### BACKGROUND OF INVENTION

1. Field of Invention

The present invention relates to a heat management system and a method for an engine. More particularly, the present invention relates to a heat management system and a method for an engine capable of preventing an engine from overheating and a cooling water temperature from excessively increasing and solving problems which may occur due to the excessive increase in the cooling water temperature.

2. Description of Related Art

An engine of a vehicle generates heat during combustion which is delivered to a cylinder wall, a cylinder head, a piston, a valve, etc., which constitutes the engine, thereby increasing the temperature of the parts of the engine. When the temperature of the parts constituting the engine excessively increases, strength of the parts degrades, such that the parts may be broken or the lifespan thereof may be shortened and an oil film of an inner wall of the cylinder may be damaged to cause lubrication badness and heat disorder.

The heat disorder of the engine causes abnormal combustion, such as combustion miss, knocking, and early ignition, which leads to serious damages such as a melting loss of a piston and the reduction in heat efficiency and output of the engine. Therefore, the vehicle is provided with a cooling system for discharging the heat of the engine to the outside and most of the vehicles adopt a water cooling system which circulates cooling water to heat generation parts such as an engine.

In a water-cooled engine, a cooling water passage is connected between the engine and a radiator and a water pump for circulating the cooling water and a thermostat for controlling a cooling water flow are provided on the cooling water passage. Further, a water jacket is provided around a combustion chamber of a cylinder block and the cooling water passes through the water jacket of the engine to exchange heat between the cooling water and the cylinder block, thereby appropriately cooling the cylinder block. Further, a portion of the cooling water flows in an oil cooler side and thus may also be used for oil cooling.

However, although the cooling system is provided in the vehicle, recently, a high-performance engine is mounted in the vehicle and thus a problem of engine cooling performance, a heat damage problem around an exhaust system, and the like which are not caused in the past may occur.

In particular, it is difficult to manage the cooling water temperature which is directly affected by the temperature of the engine. Therefore, the cooling water temperature excessively increases under severe service conditions, such as high speed driving, hill route driving, and the like, such that problems, such as a boiling and fog phenomenon of the cooling water occurring in a reservoir and a cooling water leakage due to overflow, may occur.

In addition, excessive humidity and fog occur in a windshield glass due to a cut off control of an air conditioner compressor depending on the excessive increase in the cooling water temperature while driving, such that a fatal result to safety driving, such as a disabled state of driving, may occur.

Meanwhile, torque reduction logic which limits an injection quantity of fuel at the time of the excessive increase in fuel temperature has been known as a heat management technology of a vehicle, which is restrictively used only as the restricted technology of preventing the fuel temperature from increasing.

Further, in the vehicle to which the torque reduction logic is applied, a driver may feel disharmony and dissatisfaction due to the sudden reduction in a torque and reduction in a vehicle speed in the state in which the driver does not recognize a torque reduction mode entry.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art and/or other problems. The present invention has been made in an effort to provide a heat management system and a method for an engine capable of preventing an engine from overheating and a cooling water temperature from excessively increasing and solving problems which may occur due to the excessive increase in the cooling water temperature.

Further, the present invention has been made in an effort to provide a system and a method providing control state information to a driver during a heat management process for an engine to allow the driver to directly recognize the control state of the vehicle.

In various aspects, the present invention provides a heat management system for an engine, including: a cooling water temperature sensor configured to detect an engine cooling water temperature; an engine control unit configured to determine whether the engine control unit enters a torque reduction mode depending on the cooling water temperature detected by the cooling water temperature sensor and perform an engine control to reduce an engine torque in a torque reduction mode entry condition; and a display unit configured to be controlled by the engine control unit to display whether the engine control unit enters the torque reduction mode.

In various other aspects, the present invention provides a heat management method for an engine, including: detecting an engine cooling water temperature using a cooling water temperature sensor; determining, by an engine control unit, whether the engine control unit enters a torque reduction mode depending on the cooling water temperature detected by the cooling water temperature sensor and performing an engine control to reduce an engine torque in a torque reduction mode entry condition; and controlling, by the engine control unit, a display unit to display entry of the torque reduction mode if the engine control unit enters the torque reduction mode.

In an aspect, the engine control unit may compare the cooling water temperature detected by the cooling water temperature sensor with a preset temperature and may perform the engine control in the torque reduction mode if the cooling water temperature is equal to or higher than the preset temperature. In another aspect, the engine control unit may enter the torque reduction mode if the cooling water temperature is equal to or higher than the preset temperature for a predetermined time.

In some aspects, the engine control unit may limit the engine torque to a preset maximum allowable torque in the torque reduction mode. In one aspect, when it is determined that the engine control unit enters the torque reduction mode, the engine control unit may perform the engine control to reduce the engine torque gradually or stepwise until the engine torque reaches the preset maximum allowable torque.

In some aspects, the display unit may include a display window or a display lamp or both within a cluster. In one aspect, the display unit may display entry of the torque reduction mode for engine protection with a character or characters.

According to the heat management system and method for an engine of the present invention, when the engine cooling water temperature increases to the set temperature or more, it is possible to solve the general problems due to the engine overheating by reducing the engine output torque to protect the engine.

In particular, it is possible to solve the problems which may occur due to the excessive increase in the cooling water temperature under the severe service conditions, such as high speed driving, hill route driving, and the like, for example, the problems, such as the boiling and fog phenomenon of the cooling water occurring in the cooling water reservoir and the cooling water leakage due to the overflow.

Further, it is possible to solve the problems of the humidity and fog occurrence of the windshield glass due to the inoperable state of the air conditioner under the severe service conditions by previously preventing the water temperature from arriving at the cut off entry temperature of the air conditioner compressor by inducing the stabilization of the cooling water temperature.

In addition, it is possible to allow the driver to accurately recognize the vehicle control state and to induce the safe vehicle driving by displaying the torque reduction mode entry and release on the display unit in consideration of the disharmony at the time of the torque reduction mode entry.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a configuration diagram of an exemplary heat management system for an engine according to the present invention;

FIG. 2 is a flow chart illustrating an exemplary heat management method for an engine according to the present invention;

FIG. 3 is a diagram illustrating an example in which an engine torque is controlled to be reduced depending on a cooling water temperature according to the present invention; and

FIG. 4 is a diagram illustrating a display unit within a cluster informing a torque reduction mode entry in an exemplary heat management system of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention provide a heat management system and method for an engine capable of preventing an engine from overheating and a cooling water temperature from excessively increasing and solving problems which may occur due to the excessive increase in the cooling water temperature.

Unlike the related art requires more comprehensive and integrated torque reduction logic for preventing an engine from overheating than fuel temperature, various embodiments of the present invention perform a control of a torque reduction mode depending on a cooling water temperature, not on the fuel temperature. Further, according to various embodiments of the present invention, a control state for managing engine heat is displayed and then is transferred to a driver, such that the driver may directly recognize a current vehicle control state.

That is, to minimize disharmony and dissatisfaction of a driver due to the sudden reduction in a vehicle speed at the time of a torque reduction mode entry, a torque reduction mode entry and release state is accurately transferred to the driver, such that the driver may directly recognize that a current vehicle state is a vehicle speed reduction state due to the torque reduction mode entry.

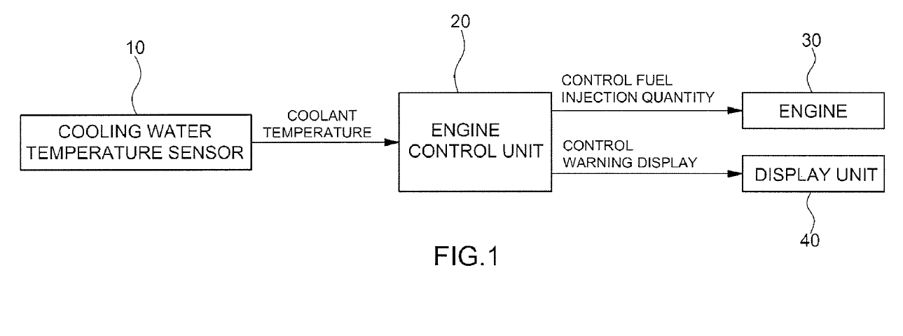

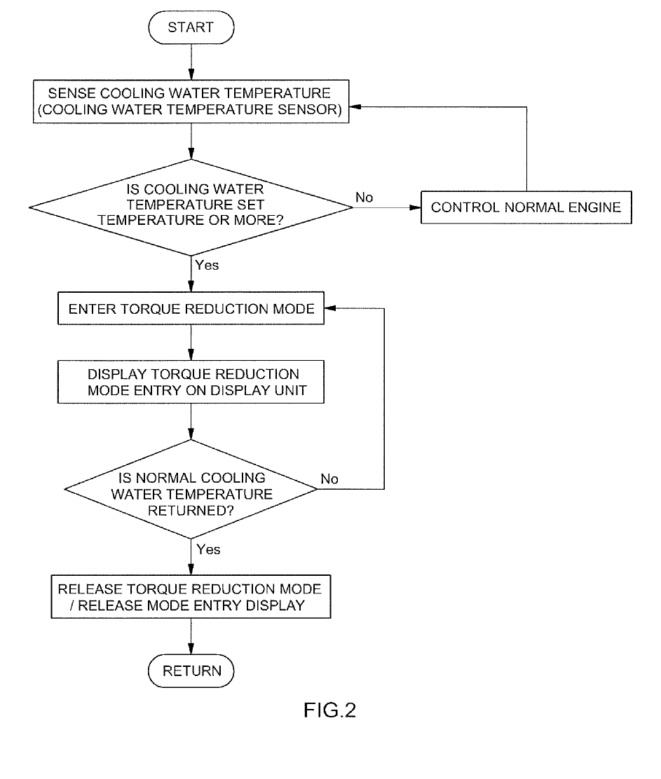

FIG. 1 is a configuration diagram of a heat management system for an engine according to various embodiments of the present invention and FIG. 2 is a flow chart illustrating a heat management method for an engine according to various embodiments of the present invention.

As illustrated in FIG. 1, the heat management system for an engine according to various embodiments of the present invention is configured to include a cooling water temperature sensor 10, an engine control unit (ECU) 20, and a display unit 40.

The cooling water temperature sensor (water temperature sensor) 10 is a water temperature sensor (WTS) which is mounted in a cooling water passage of an engine to detect a cooling water temperature and is provided to output an electrical signal depending on the cooling water temperature to the engine control unit 20.

The engine control unit 20 compares the cooling water temperature detected by the cooling water temperature sensor 10 with a preset temperature while the vehicle is driven to operate an engine 30 to perform a normal control of fuel injection and an engine control depending on a driver demand in a normal state in which the cooling water temperature is less than the set temperature.

On the other hand, in a high temperature state in which the cooling water temperature is the set temperature or more, the engine control unit 20 performs a torque reduction control. That is, when the cooling water temperature increases to the set temperature or more, to prevent the engine from overheating and protect the engine, the engine control unit 20 enters the torque reduction mode to perform the torque reduction control which reduces an output torque of the engine 30.

In this case, the engine control unit 20 enters the torque reduction mode in the condition that the cooling water temperature detected by the cooling water temperature sensor 10 is kept to be the set temperature or more for a predetermined time and in the torque reduction mode, the engine control unit 20 reduces an engine torque (driving torque) to satisfy a preset maximum allowable torque.

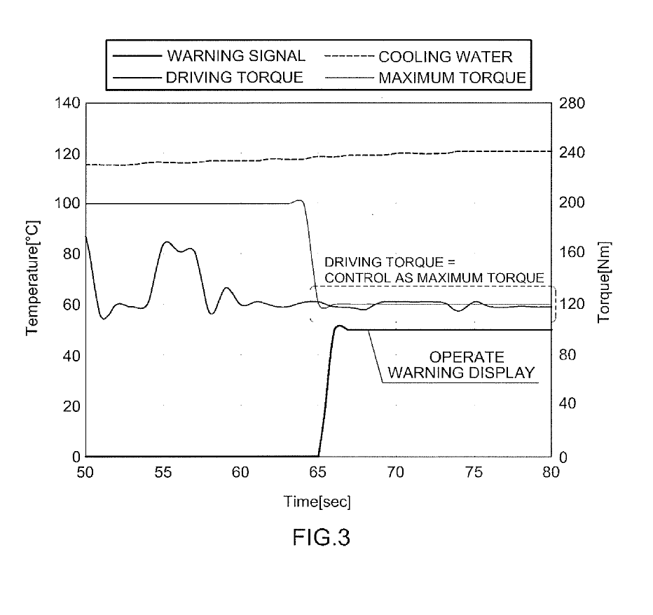

FIG. 3 is a diagram illustrating an example in which an engine torque is controlled to be reduced at the time of the torque reduction mode entry depending on a cooling water temperature, in which the normal engine torque control is performed depending on the driver demand and then when the cooling water temperature increases to the set temperature or more, the engine torque is limited so as not to exceed the maximum allowable torque while the torque reduction mode is kept.

Referring to FIG. 3, when the maximum allowable torque is set in a normal control mode while the normal fuel injection control and the engine control are performed, not in the torque reduction mode, and the cooling water temperature increases to the set temperature or more, the maximum allowable torque in the entering torque reduction mode is set.

When the engine is in a state in which the engine is driven at a high output torque in the normal control mode and then enters the torque reduction mode due to the increase in the cooling water temperature to the set temperature or more, the engine control unit 20 reduces the engine torque to the set maximum allowable torque after the torque reduction mode entry and limits the engine torque to the maximum allowable torque even though there is the driver demand during the torque reduction mode entry.

The engine control unit 20 controls a fuel injection quantity of the engine 30 to control the engine torque satisfying the maximum allowable torque during the torque reduction mode and reduces the fuel injection quantity in order to reduce the engine torque from the previous torque to the maximum allowable torque at the time of the torque reduction mode entry.

In this case, to prevent the vehicle speed from suddenly and excessively reducing at the time of the torque reduction mode entry, the engine control unit 20 may be set to reduce the fuel injection quantity of the engine gradually or stepwise. Therefore, the engine torque is reduced to the maximum allowable torque gradually or stepwise to prevent the vehicle speed from suddenly reducing and minimize the disharmony and dissatisfaction of the driver.

Further, the engine control unit 20 displays that the current vehicle control state enters the torque reduction mode through the display unit 40 at the time of the torque reduction mode entry to inform the driver of the vehicle control state. In this case, the display unit 40 may be a display window which is mounted in a cluster or may be a display lamp within the cluster.

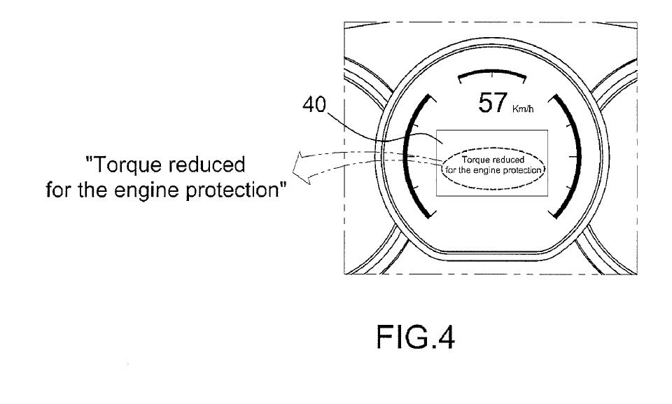

FIG. 4 is a diagram illustrating a display unit 40 within the cluster informing the torque reduction mode entry. According to various embodiments of the present invention, the display unit 40 may be provided to display the mode entry state with a character so as to enable a driver to accurately recognize the torque reduction mode entry state, such that the driver may directly recognize the vehicle control state, thereby enabling the driver to safely drive the vehicle.

For example, the display window within the cluster as the display unit 40 may be configured to display words indicating that the torque is reduced to protect the engine, for example, a message of “Torque reduced for the engine protection”. Alternatively, as the display unit 40, the display lamp which may display the words of “Torque reduced for the engine protection” within the cluster may be configured to be lit up.

Next, when the cooling water temperature detected by the cooling water temperature sensor 10 falls and thus the torque reduction mode release condition is satisfied, the torque reduction mode is released and a mode display state displayed on the display unit 40 is released.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heat management system for an engine, comprising:
a cooling water temperature sensor configured to detect an engine cooling water temperature;
an engine control unit configured to determine whether the engine control unit enters a torque reduction mode depending on the cooling water temperature detected by the cooling water temperature sensor and perform an engine control to reduce an engine torque in a torque reduction mode entry condition; and
a display unit configured to be controlled by the engine control unit to display whether the engine control unit enters the torque reduction mode.

2. The heat management system for an engine of claim 1, wherein the engine control unit compares the cooling water temperature detected by the cooling water temperature sensor with a preset temperature and performs the engine control in the torque reduction mode if the cooling water temperature is equal to or higher than the preset temperature.

3. The heat management system for an engine of claim 2, wherein the engine control unit enters the torque reduction mode if the cooling water temperature is equal to or higher than the preset temperature for a predetermined time.

4. The heat management system for an engine of claim 1, wherein the engine control unit limits the engine torque to a preset maximum allowable torque in the torque reduction mode.

5. The heat management system for an engine of claim 4, wherein when it is determined that the engine control unit enters the torque reduction mode, the engine control unit performs the engine control to reduce the engine torque gradually or stepwise until the engine torque reaches the preset maximum allowable torque.

6. The heat management system for an engine of claim 1, wherein the display unit includes a display window or a display lamp or both within a cluster.

7. The heat management system for an engine of claim 1, wherein the display unit displays entry of the torque reduction mode for engine protection with a character or characters.

8. A heat management method for an engine, comprising:
detecting an engine cooling water temperature using a cooling water temperature sensor;
determining, by an engine control unit, whether the engine control unit enters a torque reduction mode depending on the cooling water temperature detected by the cooling water temperature sensor and performing an engine control to reduce an engine torque in a torque reduction mode entry condition; and
controlling, by the engine control unit, a display unit to display entry of the torque reduction mode if the engine control unit enters the torque reduction mode.

9. The heat management method for an engine of claim 8, wherein the engine control unit compares the cooling water temperature detected by the cooling water temperature sensor with a preset temperature and performs the engine control of the torque reduction mode if the cooling water temperature is equal to or higher than the preset temperature.

10. The heat management method for an engine of claim 9, wherein the engine control unit enters the torque reduction mode if the cooling water temperature is equal to or higher than the preset temperature for a predetermined time.

11. The heat management method for an engine of claim 8, wherein the engine control unit limits the engine torque to a preset maximum allowable torque in the torque reduction mode.

12. The heat management method for an engine of claim 11, wherein when it is determined that the engine control unit enters the torque reduction mode, the engine control unit performs the engine control to reduce the engine torque gradually or stepwise until the engine torque reaches the preset maximum allowable torque.

13. The heat management method for an engine of claim 8, wherein the display unit includes a display window or a display lamp or both within a cluster.

14. The heat management method for an engine of claim 8, wherein the display unit displays entry of the torque reduction mode for engine protection with a character or characters.

15. The heat management method for an engine of claim 13, wherein the display unit displays entry of the torque reduction mode for engine protection with a character or characters.

16. The heat management system for an engine of claim 6, wherein the display unit displays entry of the torque reduction mode for engine protection with a character or characters.
